(19) United States
(12) Patent Application Publication
(10) Pub. No.: US 2024/0241710 A1
(43) Pub. Date: Jul. 18, 2024

(54) INTELLIGENT OVER-THE-AIR UPDATE PERFORMANCE MANAGEMENT

(71) Applicant: Micron Technology, Inc., Boise, ID (US)

(72) Inventor: Qi Dong, Shanghai (CN)

(21) Appl. No.: 18/405,439

(22) Filed: Jan. 5, 2024

Related U.S. Application Data
(60) Provisional application No. 63/480,300, filed on Jan. 18, 2023.

(51) Int. Cl. G06F 8/65

(52) U.S. Cl. CPC G06F 8/65

(57) ABSTRACT

Exemplary methods, apparatuses, and systems include a wireless update programming manager for controlling performance of a wireless update by adjusting bit density of a set of blocks. The wireless update programming manager receives a size of an update file from a host using wireless communication. The wireless update programming manager selects an amount of memory for the update file based on the size to reallocate from a default bit density to a lower bit density than the default bit density. The wireless update programming manager programs a first portion of the update file using the memory reallocated to the lower bit density.

### CROSS-REFERENCE TO RELATED APPLICATION

The present application claims the benefit of U.S. Provisional Patent Application No. 63/480,300 filed on Jan. 18, 2023, which is incorporated by reference herein in its entirety.

### TECHNICAL FIELD

The present disclosure generally relates to managing performance of over-the-air updates in memory subsystems, and more specifically, relates to intelligent performance management of over-the-air updates.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 is a flow diagram of an example method of dynamically distributing the bit density of programming for an update file in accordance with some embodiments of the present disclosure.

FIG. 3 is a flow diagram of an example method of intelligent performance management of wireless updates in accordance with some embodiments of the present disclosure.

FIG. 4 is a block diagram of an example computer system in which embodiments of the present disclosure may operate.

### DETAILED DESCRIPTION

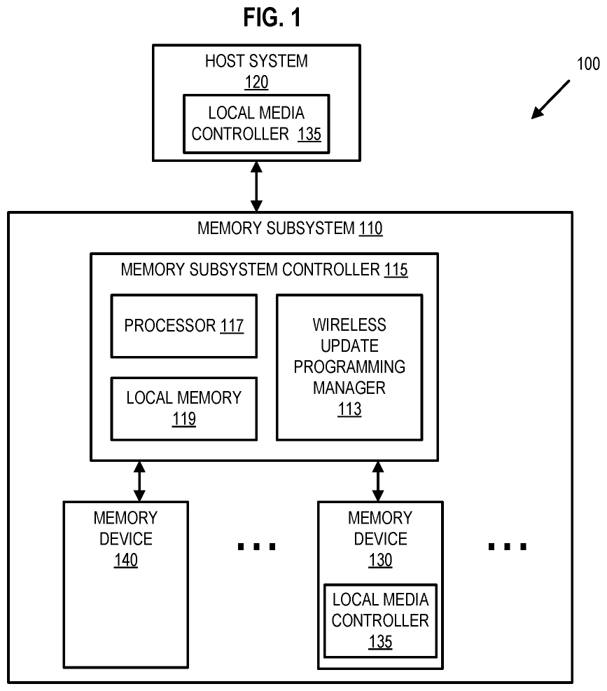

Aspects of the present disclosure are directed to managing performance of updating automotive systems. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), quad-level cells (QLCs), and octo-level cells (OLC). For example, an SLC can store one bit of information and has two logic states.

Operating environments for automotive technology systems have increasingly incorporated sophisticated driver systems and user experience features. The sophistication of these automotive systems can increase the amount of data required to update the driver systems and, accordingly, the length of time required to perform updates. For example, performing over-the-air/wireless updates on large files such as disk images or applications increases both the verification process as well as the programming process of the update. In typical systems, the data is written to the memory cells based on a default programming configuration, such as storing three bits per cell in a triple-layer cell configuration. Programming times increase as the number of bits stored per cell of memory increases. As a result, the length of time to perform an update corresponds directly to the size of the files in the update and bit density of the memory cells. For large file sizes, the length of time required can delay or disrupt operation of the vehicle for extended periods.

Aspects of the present disclosure address the above and other deficiencies by reallocating memory cells from the default programming configuration to a lower bit density for at least a portion of the update. For each size of update, the update manager chooses the amount of memory cells to be reallocated to the lower bit density for the update programming and verification. By reallocating memory cells to a lower bit density configuration, the length of time to verify and program the over-the-air update is reduced. Reducing the time to complete the update reduces the amount of time the operation of the vehicle is delayed or disrupted. Additionally, when not needed for an update, the default programming configuration of the memory cells allows the system to store more data due to the use of the higher bit density. As a result, the memory subsystem controls the bit density being allocated to memory blocks to improve write performance during the update and preserve storage performance after completion of the update.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory subsystem 110. The host system 120 can further utilize an NVM Express (NVMe) interface to access components (e.g., memory devices 130) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random-access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in a local memory 119. In the illustrated example, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processor or controller separate from the memory subsystem 110).

In general, the memory subsystem controller 115 can receive commands or operations from the host system 120 and can convert the commands or operations into instructions or appropriate commands to achieve the desired access to the memory devices 130 and/or the memory device 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory subsystem controller 115 can further include host interface circuitry to communicate with the host system 120 via the physical host interface. The host interface circuitry can convert the commands received from the host system into command instructions to access the memory devices 130 and/or the memory device 140 as well as convert responses associated with the memory devices 130 and/or the memory device 140 into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory subsystem controller 115 to execute operations on one or more memory cells of the memory devices 130. An external controller (e.g., memory subsystem controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory subsystem 110 includes a wireless update programming manager 113 that receives an update file from a host and controls the bit density of memory blocks to optimize writing the update file to memory device(s) 130. In some embodiments, the controller 115 includes at least a portion of the wireless update programming manager 113. For example, the controller 115 can include a processor 117 (processing device) configured to execute instructions stored in local memory 119 for performing the operations described herein. In some embodiments, the wireless update programming manager 113 is part of the host system 120, an application, or an operating system.

The wireless update programming manager 113 can receive update files from the host system 120. In an example, the wireless update programming manager 113 receives an over-the-air (OTA) update for an automotive system. Examples of the update file include images of applications stored in the memory devices 130. The wireless update programming manager 113 manages performance by controlling a ratio of writing at a default bit density and writing at a bit density lower than the default bit density (“lower bit density”). To determine the ratio, the wireless update programming manager 113 selects an amount of memory to reallocate from the default bit density to a lower bit density than the default bit density using the size of the update file.

In some embodiments, the wireless update programming manager 113 determines if the update file can be written entirely at the lower bit density by comparing a size of the update file to a size of the set of memory blocks allocated for the update. In an example, the wireless update programming manager 113 controls the ratio of bit density for a set of memory blocks using the size of the update file by assigning a first subset of blocks to the lower bit density and a second subset of blocks to a default bit density. For a set of memory blocks representing a 120 GB available for the update, TLC as a default bit density, and an update file size of 40 GB, the wireless update programming manager 113 selects a ratio between SLC and TLC that optimizes performance of the OTA update. The wireless update programming manager 113 assigns 90 GB of the user array to the first subset of memory blocks that represents 30 GB of the update file when the memory cells are programmed as SLC rather than TLC. The wireless update programming manager 113 assigns 10 GB of the user array to the second subset of memory blocks that represents 10 GB of the update file when the memory cells are programmed as TLC, the default bit density. Additionally, the wireless programming manager 113 can maintain some of the available memory as a buffer. In this example, a buffer of 20 GB can be assigned to the update so that the 120 GB user array includes 90 GB in the first subset of memory blocks, 10 GB in the second subset of memory blocks, and 20 GB in the buffer.

Additionally, the wireless update programming manager 113 is configured to write register values to store status and operations. For example, the wireless update programming manager 113 stores a status value in a first register (“status value register”) that indicates an in-progress status and a mode of operation. In some embodiments, the wireless update programming manager 113 performs an OTA update in manual or automatic mode as indicated by the status value. When operating in manual mode, the status value is written by the host system 120. When operating in automatic mode, the wireless update programming manager 113 resets the status value after an amount of data equal to the update file size is programmed to the set of memory blocks. In some embodiments, the wireless update programming manager 113 stores an additional value that indicates the size of the OTA update.

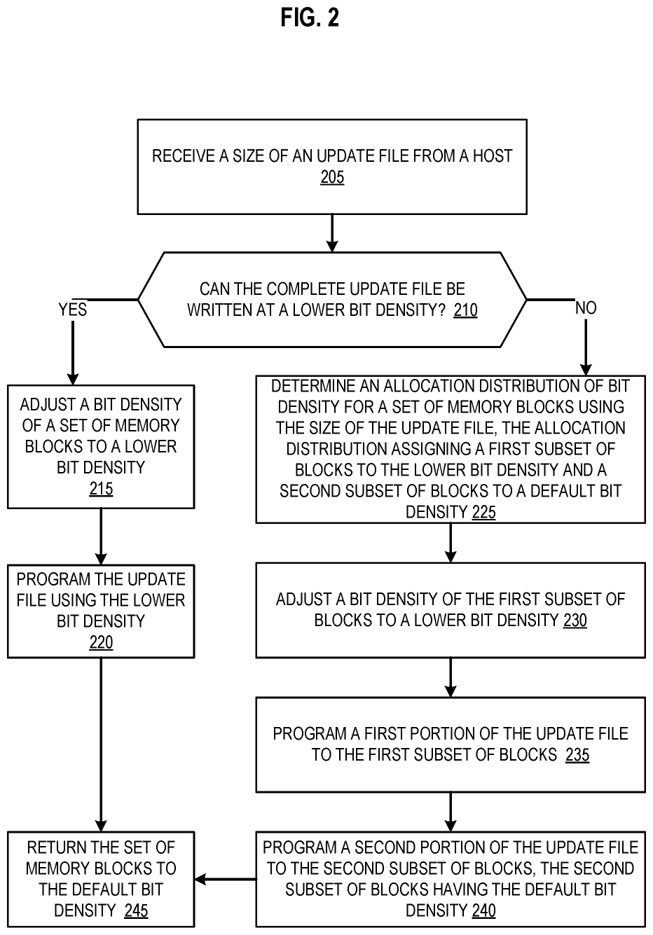

FIG. 2 is a flow diagram of an example method of dynamically distributing the bit density of programming for an update file in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the wireless update programming manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 205, the wireless update programming manager 113 receives a size of an update file from a host. In some embodiments, the wireless update programming manager 113 is configured to receive a file size associated with the update file that is being received using wireless communication. For example, the wireless update programming manager 113 can receive an indication that the update file size is 20 GB from the host system 120. Examples set forth herein refer to sets of memory blocks and files, but other subdivisions of memory and other sets/groupings of data/files can be used.

After receiving the size of the update file, the wireless update manager 113 selects an allocation of available memory for the update file based on the size as described below. Additionally, the wireless update programming manager 113 writes a value to the status value register that indicates that an OTA update is in progress and a mode of update. An allocation value is written by the wireless update programming manager 113 to a second register (“update size register”). The allocation value represents an expected written file size of the update file after programming to the set of memory blocks. The update size register is used to store the size of the update file and can be used to determine the allocation distribution or ratio of bit densities when recovering from an unexpected power loss.

In some embodiments, the wireless update programming manager 113 performs an OTA update in manual or automatic mode as indicated by the status value. In manual mode, after completion of programming the update file, the host system 120 resets the value in the status value register. In automatic mode, the wireless update programming manager 113 resets the value in the status value register after an amount of data equal to the update file size (e.g., represented by the update size register) is programmed to the set of memory blocks. The status value register is used by the wireless update programming manager 113 to monitor the OTA process and handle unexpected power loss by storing whether an OTA update is in progress and recover from power loss and resume programming the OTA update. The status value register stores a value that indicates whether the host or wireless update programming manager 113 performs the reset after the OTA update is completed after recovering from a power loss.

In some embodiments, the wireless update programming manager 113 performs an OTA update in manual or automatic mode as indicated by the status value. In manual mode, after completion of programming the update file, the host system 120 resets the value in the status value register. In automatic mode, the wireless update programming manager 113 resets the value in the status value register after an amount of data equal to the update file size (e.g., represented by the update size register) is programmed to the set of memory blocks.

At operation 210, the wireless update programming manager 113 determines if the complete update file can be written at a lower bit density. In some embodiments, a set of blocks of the memory devices 130 have a default bit density, such as TLC. Examples set forth herein refer to TLC, but the memory subsystem 110 can use other default bit densities, such as MLC, QLC, OLC, etc. To determine if the complete update file can be written at the lower bit density, the wireless update programming manager 113 compares the size of the update file to the size of memory available/allocated in the memory device 130 for the update. To program the complete update file at the lower bit density (e.g., SLC), the size of the update file at the default bit density is multiplied by the number of bits stored per cell at the default bit density. In an example, for a set of blocks that represents 20 GB of memory with a default bit density of TLC (e.g., 3 bits per cell), a lower bit density of SLC requires a set of blocks that represents 60 GB (e.g., the adjusted size) of memory. In this example, for an allocated size of the memory device that is greater than 60 GB, the complete 20 GB update file can be written in the lower bit density. If the wireless update programming manager 113 determines that the complete update file can be written at a lower bit density, the method 200 proceeds to operation 215. In another example, for a size of memory available/allocated in the memory device that is less than 60 GB, the complete update file cannot be written in the lower bit density as the adjusted size of the update file exceeds the size of memory available/allocated in the memory device 130 when written in the lower bit density. If the wireless update programming manager 113 determines that the complete update file cannot be written at a lower bit density, the method 200 proceeds to operation 225. In some embodiments, the set of blocks of the memory devices 130 include a buffer having a size that provides a subset of memory blocks for temporarily storing data. The size of the buffer can be a pre-determined value or percentage of the available memory for the memory device. In an example, the buffer is 20 GB for a 128 GB memory device with a 120 GB available user array.

At operation 215, the wireless update programming manager 113 adjusts the bit density of a set of memory blocks to a lower bit density. In some embodiments, the wireless update programming manager 113 reallocates the set of memory blocks from TLC to SLC by, e.g., updating a setting or otherwise configuring the memory subsystem to program the memory as SLC. The size of the set of blocks is determined using the size of the update file and the bit difference between the default bit density and the lower bit density. For example, the wireless update programming manager 113 adjusts 60 GB of memory blocks from TLC (which store three bits per cell by default) to SLC (storing only a single bit per cell) for an update file that has a 20 GB file size.

At operation 220, the wireless update programming manager 113 programs the update file using the lower bit density. In some embodiments, the wireless update programming manager 113 writes the update file to the set of memory blocks using SLC. The wireless update programming manager 113 writes the update file to a set of memory blocks with a single bit per cell (e.g., a 2 Vt state). After programming the update file using the lower bit density is completed, the wireless update programming manager 113 folds the set of memory blocks from the lower bit density memory to memory at the default bit density. At the completion of operation 220, the method 200 proceeds to operation 245.

Returning to operation 210, if the entire update file cannot be written at a lower bit density, the method 200 proceeds to operation 225. At operation 225, the wireless update programming manager 113 determines an allocation distribution of bit density for a set of memory blocks using the size of the update file, the allocation distribution assigning a first subset of blocks to the lower bit density and a second subset of blocks to a default bit density. As described above, the wireless update programming manager 113 compares the size of the update file to a set of memory blocks available/allocated in the memory device 130. Because writing at the lower bit density requires additional memory blocks, the wireless update programming manager 113 optimizes the first subset of blocks and the second subset of blocks to maximize performance (e.g., allocating the maximum amount of memory to the lower bit density).

In an example, for a 120 GB set of memory blocks available/allocated in the memory device for an update, TLC as a default bit density, and an update file size of 60 GB, the wireless update programming manager 113 determines an allocation distribution between SLC and TLC. The wireless update programming manager 113 assigns 60 GB of the user array to the first subset of memory blocks that represents 20 GB of the update file. In other words, the wireless update programming manager 113 allocates the maximum amount of available memory to the lower bit density while retaining sufficient remaining memory at the default bit density to receive the remaining portion of the update and reserve some memory for the buffer. The wireless update programming manager 113 assigns 40 GB of the user array to the second subset of memory blocks that represents 40 GB of the update file. A buffer of 20 GB can be assigned to a buffer so that the 120 GB set of available memory includes 60 GB in the first subset of memory blocks (but effectively capable of storing 20 GB at the lower bit density), 40 GB in the second subset of memory blocks, and 20 GB in the buffer. In some embodiments, the buffer is allocated to accommodate folding operations. For example, wireless programming manager 113 uses the buffer in the process of folding update file data from the portion of memory programmed at a lower bit density (e.g., SLC) to memory programmed at the default bit density (e.g., TLC).

At operation 230, the wireless update programming manager 113 adjusts the bit density of the first subset of blocks to the lower bit density. Similar to as described at operation 215, the wireless update programming manager 113 reallocates the first subset of memory blocks from TLC to SLC by, e.g., updating a setting or otherwise configuring the memory subsystem to program the memory as SLC. Returning to the previous example, the wireless update programming manager 113 adjusts 60 GB of memory blocks from TLC (which store three bits per cell by default) to SLC (storing only a single bit per cell) for a portion of an update file that has a 20 GB file size.

At operation 235, the wireless update programming manager 113 programs a first portion of the update file to the first subset of blocks. Continuing with the previous example, the wireless update programming manager 113 writes the first portion (e.g., 20 GB) of the update file to the set of memory blocks (e.g., 60 GB) using SLC similar to operations as described with reference to operation 220.

At operation 240, the wireless update programming manager 113 programs a second portion of the update file to the second subset of blocks, the second subset of blocks having the default bit density. Continuing with the previous example, the wireless update programming manager 113 writes the second portion (e.g., 40 GB) of the update file to the set of memory blocks (e.g., 40 GB) using TLC. After completion of programming of the update file, the wireless update programming manager 113 folds the first subset of memory blocks (e.g., written at operation 235) from the lower bit density memory to memory at the default bit density. At the completion of operation 240, the method 200 proceeds to operation 245.

At operation 245, the wireless update programming manager 113 returns the set of memory blocks to the default bit density. In some embodiments, and continuing with the example above, the wireless update programming manager 113 reallocates the set of memory blocks from SLC to TLC by, e.g., updating a setting or otherwise returning the configuration of the memory subsystem to program the memory as TLC. For example, the wireless update programming manager 113 folds the 60 GB of memory blocks from SLC described above (which store one bit per cell by default) to TLC (storing three bits per cell) for the update file that has the 20 GB file size.

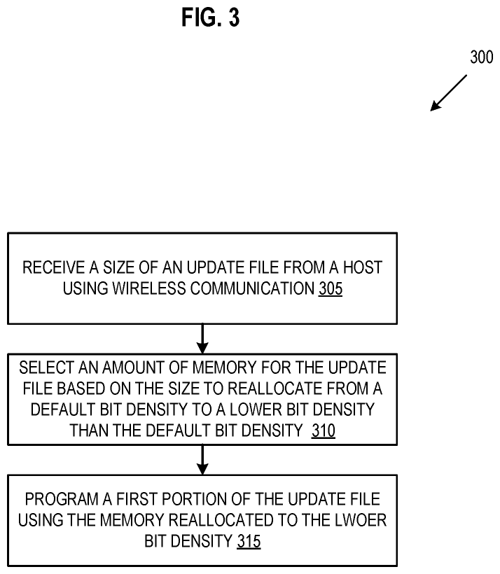

FIG. 3 is a flow diagram of an example method of intelligent performance management of wireless updates in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the wireless update programming manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, receive a size of an update file from a host using wireless communication. As described above at operation 205, the wireless update programming manager 113 is communicatively coupled to a network interface device that receives communication from the host system.

At operation 310, the wireless update programming manager 113 selects an amount of memory for the update file based on the size to reallocate from a default bit density to a lower bit density than the default bit density. As described above at operations 210, 215, 225 and 230, the wireless update programming manager 113 reallocates a portion of memory to a lower bit density by, e.g., updating a setting or otherwise configuring the memory subsystem to program the memory as SLC.

At operation 315, the wireless update programming manager 113 programs a first portion of the update file using the memory reallocated to the lower bit density. As described above at operations 220 or 235 and 240, the wireless update programming manager 113 writes the update file to memory using the lower bit density.

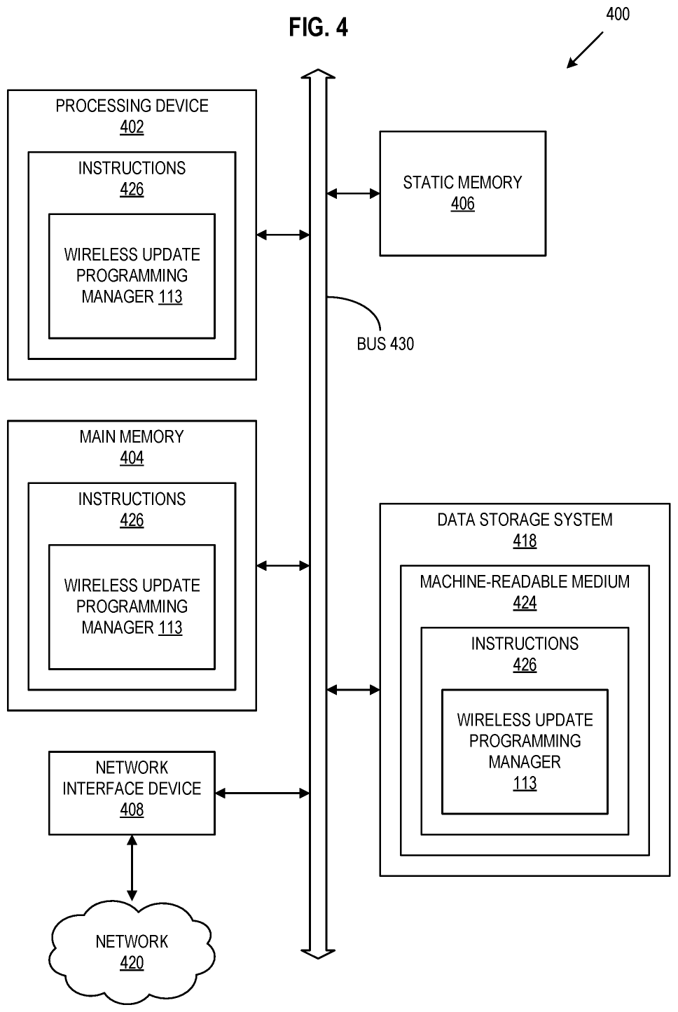

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to wireless update programming manager 113 of FIG. 1). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random-access memory (DRAM) such as synchronous DRAM (SDRAM) or Rambus DRAM (RDRAM), etc.), a static memory 406 (e.g., flash memory, static random-access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory subsystem 110 of FIG. 1.

In one embodiment, the instructions 426 include instructions to implement functionality corresponding to a wireless update programming manager (e.g., the wireless update programming manager 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 200 and 300 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a size of an update file from a host using wireless communication;
selecting an amount of memory for the update file based on the size to reallocate from a default bit density to a lower bit density than the default bit density; and
programming the update file using the memory reallocated to the lower bit density.

2. The method of claim 1, wherein selecting the amount of memory to reallocate from a default bit density to a lower bit density than the default bit density comprises:
computing an adjusted size of the update file by multiplying the size by a number of bits per cell used in the default bit density; and
comparing the adjusted size of the update file with an available memory size.

3. The method of claim 2, further comprising:
determining that the adjusted size of the update file is equal to or less than the available memory size; and
in response to determining that adjusted size of the update file at the lower bit density is equal to or less than the available memory size, selecting the amount of memory that represents the adjusted size of the update file.

4. The method of claim 2, further comprising:
determining that the adjusted size of the update file is greater than the available memory size; and
in response to determining that the adjusted size of the update file is greater than the available memory size, selecting a first amount of memory to reallocate from a default bit density to a lower bit density than the default bit density; and
selecting a second amount of memory for allocation at the default bit density to the programming of the update file.

5. The method of claim 4, wherein the lower bit density is single-level cell.

6. The method of claim 4, further comprising folding the first amount of memory to the default bit density.

7. The method of claim 6, wherein the default bit density is a triple-level cell, quad-level cell, or octo-level cell.

8. A non-transitory computer-readable storage medium comprising instructions that, when executed by a processing device, cause the processing device to:
receive a size of an update file from a host using wireless communication;
select an amount of memory for the update file based on the size to reallocate from a default bit density to a lower bit density than the default bit density; and
program a first portion of the update file using the memory reallocated to the lower bit density.

9. The non-transitory computer-readable storage medium of claim 8, wherein to select the amount of memory to reallocate from the default bit density to the lower bit density, the processing device is further caused to
compute an adjusted size of the update file by multiplying the size by a number of bits per cell used in the default bit density; and
compare the adjusted size of the update file with an available memory size.

10. The non-transitory computer-readable storage medium of claim 9, wherein the processing device is further caused to:
determine that the adjusted size of the update file is equal to or less than the available memory size; and
in response to determining that adjusted size of the update file at the lower bit density is equal to or less than the available memory size, select the amount of memory that represents the adjusted size of the update file.

11. The non-transitory computer-readable storage medium of claim 9, wherein the processing device is further caused to:
determine that the adjusted size of the update file is greater than the available memory size; and
in response to determining that the adjusted size of the update file is greater than the available memory size, select a first amount of memory to reallocate from a default bit density to a lower bit density than the default bit density; and
select a second amount of memory for allocation at the default bit density to the programming of the update file.

12. The non-transitory computer-readable storage medium of claim 11, wherein the lower bit density is single-level cell.

13. The non-transitory computer-readable storage medium of claim 12, wherein the processing device is further caused to fold the first amount of memory to the default bit density.

14. The non-transitory computer-readable storage medium of claim 13 wherein the default bit density is a triple-level cell, quad-level cell, or octo-level cell.

15. The non-transitory computer-readable storage medium of claim 14, wherein to select an allocation for the update file based on the size, the processing device is further caused to write a status value in a first register and a second allocation value in a second register, wherein the second allocation value represents the size of the update file.

16. A system comprising:
a plurality of memory devices; and
a processing device, operatively coupled with the plurality of memory devices, to:
receive a size of an update file from a host using wireless communication;
select an amount of memory for the update file based on the size to reallocate from a default bit density to a lower bit density than the default bit density, wherein the default bit density is a triple-level cell, quad-level cell, or octo-level cell; and
program a first portion of the update file to the memory reallocated to the lower bit density, wherein the lower bit density is single-level cell.

17. The system of claim 16, wherein to select the amount of memory to reallocate from the default bit density to the lower bit density, the processing device is further caused to
compute an adjusted size of the update file by multiplying the size by a number of bits per cell used in the default bit density; and
compare the adjusted size of the update file with an available memory size.

18. The system of claim 17, wherein the processing device is further caused to:
determine that the adjusted size of the update file is equal to or less than the available memory size; and
in response to determining that adjusted size of the update file at the lower bit density is equal to or less than the available memory size, select the amount of memory that represents the adjusted size of the update file.

19. The system of claim 17, wherein the processing device is further caused to:
determine that the adjusted size of the update file is greater than the available memory size; and
in response to determining that the adjusted size of the update file is greater than the available memory size, select a first amount of memory to reallocate from a default bit density to a lower bit density than the default bit density; and
select a second amount of memory for allocation at the default bit density to the programming of the update file.

20. The system of claim 19, wherein the processing device is further caused to fold the first amount of memory to the default bit density.
